(19) United States
(12) Patent Application Publication
(10) Pub. No.: US 2007/0068219 A1
(43) Pub. Date: Mar. 29, 2007

(54) Apparatus for calibrating a measurement instrument

(76) Inventor: Gabriele Balboni, San Giovanni In Persiceto (IT)

Correspondence Address: YOUNG & THOMPSON, 745 SOUTH 23RD STREET, 2ND FLOOR, ARLINGTON, VA, 22202, US

(21) Appl. No.: 10/576,309

(22) PCT Filed: Oct. 19, 2004
(86) PCT No.: PCT/IB04/03421

§ 371 Date: May 19, 2006

(30) Foreign Application Priority Data
Oct. 20, 2003 (IT) BO2003A000615
Oct. 1, 2004 (IT) BO2004A000608

(51) Int. Cl. G01P 21/00

(52) U.S. Cl. 73/1.79

(57) ABSTRACT

An apparatus (10) for calibrating measuring instruments (11), such as bore gauges and the like, includes elements for supporting the apparatus, elements for calibrating the instrument and at least one adapter element (50), that holds a desired instrument to be calibrated on the calibrating elements.

### TECHNICAL FIELD

This invention relates to an apparatus for calibrating a measuring instrument.

### BACKGROUND ART

Traditionally, the calibration of instruments for measuring a feature, such as a bore, of a mechanical part is performed manually using a plurality of standard size parts, one for each measurement reading.

Another prior art apparatus for calibrating a measuring instrument comprises a mounting structure and means for calibrating the instrument which, however, must be held firmly in position by operators while it contacts the reference surfaces of the calibrating apparatus.

Under these circumstances, however, calibration tends to be imprecise because it is very difficult for operators to hold the instrument in their hands in exactly the right position for optimum calibration.

For this reason, the trade feels a general need for calibrating means that can be applied to instruments for measuring mechanical features and that permit calibration to be carried out quickly, easily and accurately without having to use a large number of standard forms for all the calibration measurements.

### SUMMARY OF THE INVENTION

Therefore it has been provided an apparatus to be used for calibrating measuring instruments, such as bore gauges and the like, and comprising means for supporting the apparatus and calibrating means having contact means for the respective measuring ends of the instruments to be calibrated, these means being, for each end of the measuring instrument to be calibrated, in the form of a first and a second contact surface; the apparatus being characterised in that it comprises at least one adapter element on at least one of the contact surfaces of the calibrating apparatus, said adapter element being designed to receive and support a respective end of the measuring instrument by adjusting to its profile.

This makes it possible to support the instrument to be calibrated in optimum manner so that the calibrations of the measuring instrument are decidedly more accurate than those that would be obtained using the methods known to prior art.

Further, by using a plurality of these adapter elements, each one being designed to support a respective instrument, a single apparatus can be used to calibrate a large number of measuring instruments of many different types and sizes.

This invention also relates to an advantageous method for calibrating the measuring instrument and to an advantageously and especially configured adapter element.

The other claims relate to other advantageous aspects of the invention.

### BRIEF DESCRIPTION OF THE DRAWINGS

The technical characteristics of the invention are clearly described in the claims below and its advantages are apparent from the detailed description which follows, with reference to the accompanying drawings which illustrate preferred embodiments of the invention provided merely by way of example without restricting the scope of the inventive concept, and in which:

FIG. 1 is a schematic perspective view of a first preferred embodiment of the apparatus according to the present invention;

FIG. 2 is a schematic perspective view of the inside of the first preferred embodiment of the apparatus according to the present invention;

FIG. 3 is a schematic perspective view from above of the fixed head of the first preferred embodiment of the apparatus according to the present invention;

FIG. 4 is a schematic perspective view from below of the fixed head of the first preferred embodiment of the apparatus according to the present invention;

FIG. 5 is a schematic lateral cross section of the fixed head of the first preferred embodiment of the apparatus according to the present invention;

FIG. 6 is a schematic front cross section of the fixed head of the first preferred embodiment of the apparatus according to the present invention;

FIG. 7 is a schematic front view of a first preferred embodiment of an adapter according to the present invention;

FIG. 8 is a schematic plan view from below of the first preferred embodiment of the adapter according to the present invention;

FIG. 9 is a schematic central longitudinal cross section of the fixed head of the first preferred embodiment of the apparatus according to the present invention;

FIG. 10 is a schematic front view of a second preferred embodiment of the adapter according to the present invention;

FIG. 11 is a schematic plan view from above of the second preferred embodiment of the adapter according to the present invention;

FIG. 12 is a schematic central longitudinal cross section of the second preferred embodiment of the adapter according to the present invention;

FIG. 13 is a schematic front view of a third preferred embodiment of the adapter according to the present invention;

FIG. 14 is a schematic plan view from above of the third preferred embodiment of the adapter according to the present invention;

FIG. 15 is a schematic central longitudinal cross section of the third preferred embodiment of the adapter according to the present invention;

FIG. 16 is a schematic front view of a fourth preferred embodiment of the adapter according to the present invention;

FIG. 17 is a schematic plan view from below of the fourth preferred embodiment of the adapter according to the present invention;

FIG. 18 is a schematic central longitudinal cross section of the fourth preferred embodiment of the adapter according to the present invention;

FIG. 19 is a schematic front view of a fifth preferred embodiment of the adapter according to the present invention;

FIG. 20 is a schematic plan view from below of the fifth preferred embodiment of the adapter according to the present invention;

FIG. 21 is a schematic central longitudinal cross section of the fifth preferred embodiment of the adapter according to the present invention;

FIG. 22 is a schematic front view of a sixth preferred embodiment of the adapter according to the present invention;

FIG. 23 is a schematic plan view from below of the sixth preferred embodiment of the adapter according to the present invention;

FIG. 24 is a schematic central longitudinal cross section of the sixth preferred embodiment of the adapter according to the present invention;

FIG. 25 is a perspective view of a second preferred embodiment of the apparatus according to the present invention, for calibrating measuring instruments, illustrated in the closed condition;

FIG. 26 is a schematic perspective view of the inside of the second preferred embodiment of the apparatus according to the present invention;

FIG. 27 is a schematic perspective view showing only the contact heads of the second preferred embodiment of the apparatus;

FIG. 28 is a schematic perspective view showing in particular the front of the second preferred apparatus;

FIG. 29 is a perspective view showing a seventh preferred adapter in the working condition;

FIG. 30 is a front perspective view of the seventh preferred adapter;

FIG. 31 is a schematic front view of the seventh adapter as fitted on the fixed head;

FIG. 32 is a schematic perspective view from above of the seventh preferred embodiment of the adapter mounted on the fixed head;

FIG. 33 is a side view of the seventh preferred adapter as mounted on the fixed head;

FIG. 34 shows an eighth preferred adapter in the working condition on the machine;

FIG. 35 is a schematic perspective view of a first component of the eighth preferred adapter;

FIG. 36 is a schematic perspective view of a second component of the eighth preferred adapter;

FIG. 37 is a schematic perspective view showing a ninth preferred adapter in the working condition;

FIG. 38 is a schematic perspective view of a first component of the ninth preferred embodiment;

FIG. 39 is a schematic perspective view of a second component of the ninth preferred adapter;

FIG. 40 is a schematic perspective exploded view of a tenth preferred adapter shown separated from the head with which it is associated;

FIG. 41 is a schematic perspective view showing a tenth preferred adapter as mounted on the work heads of the apparatus according to the invention;

FIG. 42 is a schematic perspective view showing an eleventh preferred adapter in the working condition;

FIG. 43 is a schematic perspective view of the eleventh preferred adapter;

FIG. 44 is a schematic perspective view of a twelfth preferred adapter;

FIG. 45 is a schematic perspective view of a third preferred embodiment of the apparatus according to the present invention.

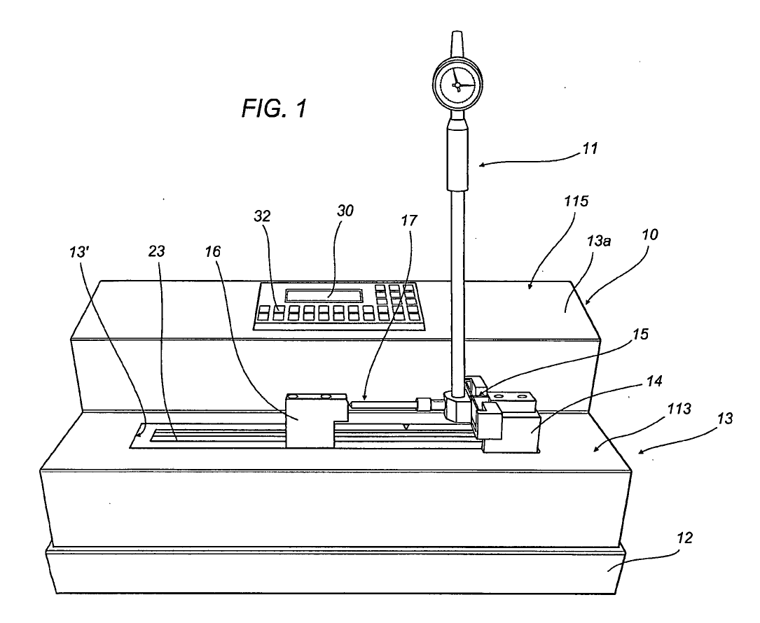

### DESCRIPTION OF THE PREFERRED EMBODIMENTS OF THE INVENTION

With reference to the accompanying drawings, an apparatus 10 according to this invention, in a first preferred embodiment of it, is used for calibrating a measuring instrument 11 such as a bore gauge, a groove gauge and the like.

As is known, bore gauges and other measuring instruments of similar kind, have gauging ends that vary considerably according to the type, size and manufacturer of the measuring instrument.

The apparatus according to the invention comprises means for supporting the apparatus, consisting of a frame 13, which in turn comprises a cover 13a that is made from a shaped metal sheet and has a long transversal opening 13′ from which the contact heads extend out of the apparatus.

The cover 13a has a stepped shape defined by a lower section 113, forming a substantially horizontal flat surface from which the means that support the measuring instrument extend, and an upper section 115, forming a flat surface that is inclined slightly forward and supports the apparatus controlling means described in more detail below.

As illustrated, the means for supporting the apparatus also comprise a relatively thick base plate 12, which is made preferably of granite.

Means are also provided for calibrating the measuring instrument.

These calibrating means comprise means for coming into contact with a first gauging end 14 of the instrument 11 to be calibrated and a second gauging end 17 of the instrument 11 itself.

The contact means comprise a fixed block 14 that supports one end 15 of the measuring instrument and has a surface 31—made preferably of ceramic or other suitable material—for coming into contact with the end of the instrument, and a mobile block 16 that also has a contact surface 33d, made preferably of ceramic or other suitable material, for the other end of the measuring instrument.

As illustrated, the block 14 and the block 16 are positioned along a horizontal line extending transversally to the apparatus.

Means are also provided for driving the mobile block.

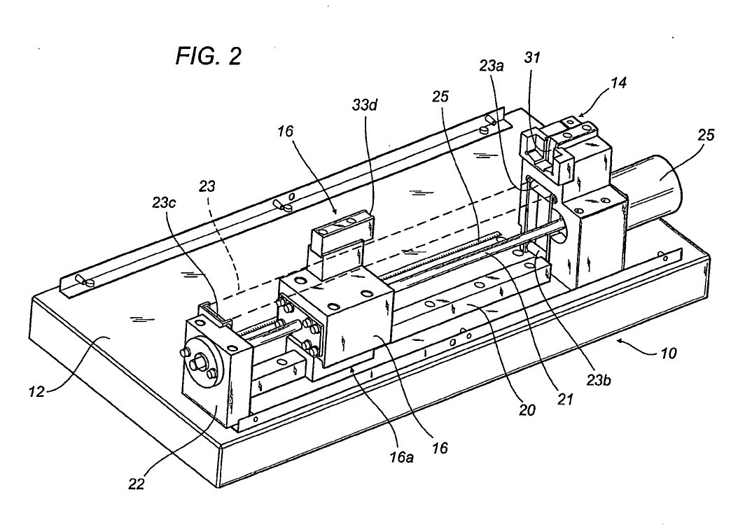

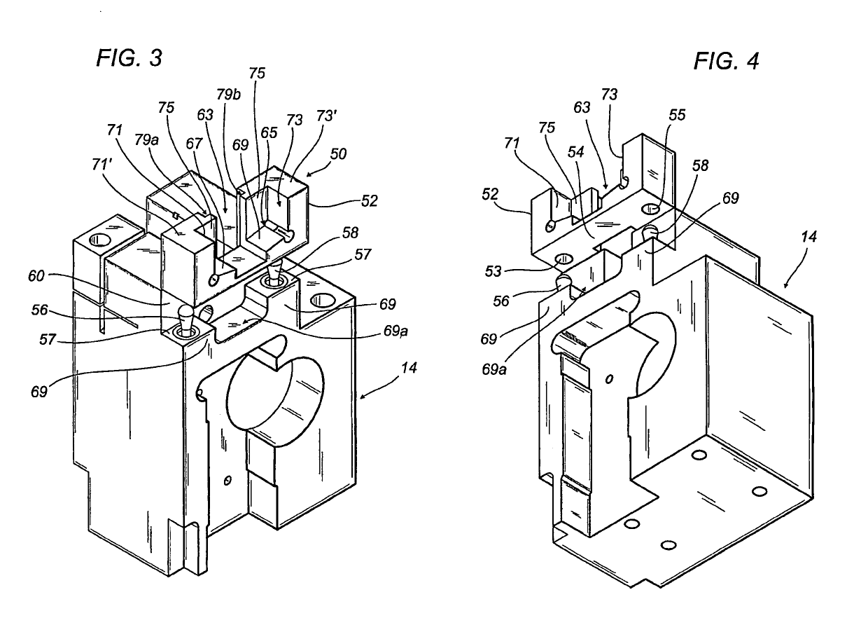

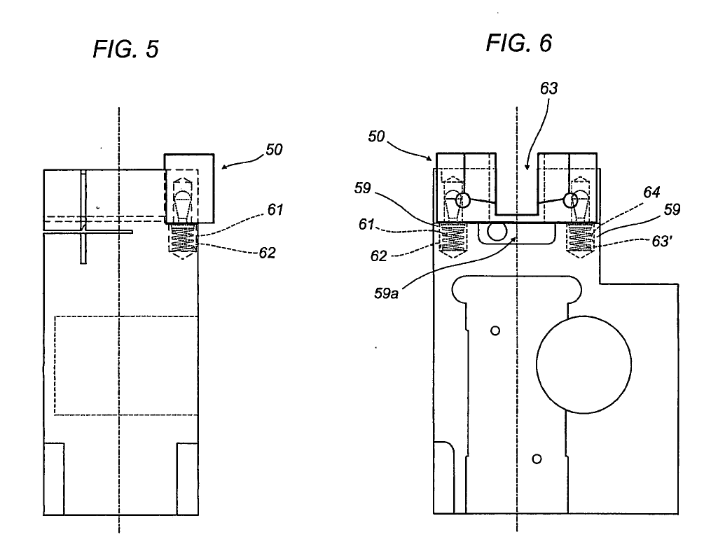

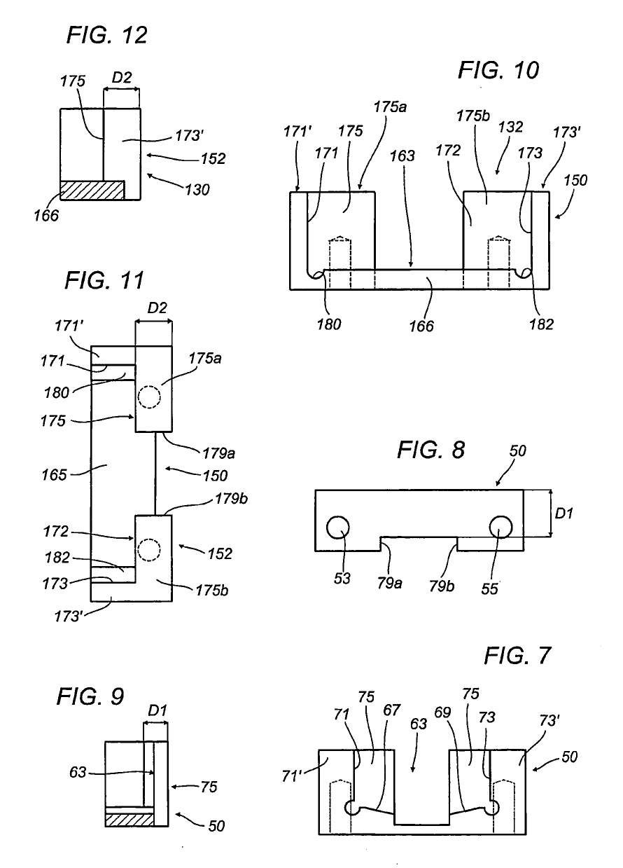

As shown in particular in FIG. 2, the means for driving the mobile block comprise mobile block guiding means that comprise a rod 20, of quadrangular cross section, extending transversally between the fixed block 14 and an opposite fixed block 22.

The lower end 16a of the mobile block, which has a matching quadrangular profile, runs on the rod 20.

The mobile block drive means also comprise means for feeding the mobile block which in turn comprise a rotary shaft 21, of circular cross section, that is vertically aligned with the guide rod 20 fixed to the base plate and that also extends transversally between the fixed block 14 and an opposite fixed block 22.

On the rod 21 there operates an instant locking feed mechanism, housed in the head 16 and not illustrated in detail in the accompanying drawings, for example an instant locking feed mechanism made by the German company UHING, which, by rotating the shaft, advances the slider 16, and stops the slider 16 in the desired position to a great degree of precision as soon as the shaft is stopped. Obviously, any other device suited to the purpose might also be used.

The mobile head is driven lengthways along the guide rod 20 by a motor 25 which rotationally drives the shaft 21, said motor being mounted, as illustrated, on the fixed head 14.

There is also provided a tape 23 (illustrated by the dashed line) which closes the groove 13′ when the mobile block moves. The tape 23 is fitted between the fixed heads 14 and 22 and is appropriately connected to the mobile head 16 and runs on a pair of rollers 23a, 23b forming part of the fixed head 14 and on a similar pair of rollers forming part of the fixed head 22, only one of these, labelled 23c, being illustrated in FIG. 2.

Control or processing means are also provided. These means comprise a CPU, a memory unit, a display unit 30, a keyboard 32 and CPU signal input/output means.

Means are also provided for determining the calibration measurement.

The means for determining the calibration measurement comprise means for detecting the relative distance between the fixed contact surface 31 and the mobile contact surface 33d or for detecting the position of the mobile block 16, which comprise a sensor, preferably magnetic, mounted on the mobile block 16, and a graduated rod 25 supported by the base plate 12 in front of the means for driving the mobile block 16.

The magnetic sensor is directed at the graduated rod and sends corresponding signals when it passes by the millimetre marks on the graduated rod.

The apparatus according to the invention also comprises adapting means consisting, more particularly, of an adapter element 50 positioned on the fixed block 14 and enables a respective measuring instrument 11 to be placed on the device.

The adapter element 50 consists of an abutting member 52 constituting means for supporting a shaped end 15 of the measuring instrument 11.

The abutting member 52 comprises a groove 63 which opens into the rear wall of this part and forms a passage for the end 15 of the measuring instrument 11 which extends towards and against the contact surface 31 of the fixed block 14.

Means are also provided for connecting the adapter 50 to the fixed block.

The means for connecting the adapter 50 to the mounting block 14 comprise a first and a second hole 53, 55 that open onto a horizontal flat bottom surface 54 of the abutting member 52.

The means for connecting the adapter 50 to the head 14 comprise, on the head 14, a first and a second pin 56, 58 to be inserted into matching holes 53, 55 and protruding from a corresponding horizontal flat surface 57 on which the bottom surface 54 of the adapter rests.

The surfaces 57 are made on short vertical columns 69 between which there is a space 69a where the operator can easily insert a hand to grip and remove the adapter to change it with an adapter for another instrument.

Means are also provided for retaining the abutting member 52, these means being in the form of spring means designed to push the abutting member 52 towards and against an opposite vertical surface 60 of the fixed block 14.

The spring pins 56, 58 and the supporting wall or surface constitute means for positioning the adapter.

The spring pushing means comprise springs 61, 63′, each supporting a respective insertion pin 56, 58 and being oriented vertically and housed in respective vertical holes 62, 64 made in the fixed block 14.

The abutting member 52 comprises lateral and vertical abutting surfaces 71 and 73 for opposite side portions of the shaped end 15 of the measuring instrument 11, each of the lateral surfaces being defined by a first and a second side wall 71′, 73′.

In practice, the bore gauge is placed with its side portions between the surfaces 71 and 73, which contain it laterally, with a certain clearance if necessary.

The abutting member 52 further comprises a rear surface abutting against the shaped end 15 of the measuring instrument 11, this rear surface being provided by a rear wall 75 of defined thickness D1 such that the ends of the measuring instrument 11 yield elastically to it to a predetermined extent. It is known that measuring instruments have elastically retractile ends to enable the gauging tip to come into contact with the surface to be measured.

The abutting member 52 also comprises a bottom surface 65 for supporting the shaped end 15 of the measuring instrument 11, this surface comprising a first and a second inclined part 67, 69 converging towards the inside of the adapter.

The reference numerals 79a and 79b denote longitudinal guide walls for the insertion of opposite lateral faces of the portion 31a which bears the contact surface 31.

In a second preferred embodiment of the invention, illustrated in FIGS. 10 to 12, the adapter 150 comprises an abutting member 152 with a lateral and vertical abutting surface 171, 173 for each side of the shaped end 15 of the measuring instrument 11, these surfaces being defined by a first and a second side wall 171′, 173′ located opposite each other.

The abutting member 152 further comprises a rear surface 175 abutting against the shaped end 15 of the measuring instrument 11, this rear surface being provided by a pair of rear walls 175a, 175b, separated by the groove 163 and being of defined thickness D2 such that the end 15 of the measuring instrument 11 yields elastically to them to a predetermined extent.

The abutting member 152 also comprises a bottom surface 165 for supporting the shaped end 15 of the measuring instrument 11, this surface being defined by a flat wall 166.

The abutting member 152 also comprises a bottom seat for accommodating a respective lateral end portion of the end 15 of the measuring instrument 11. This consists of a first and a second lateral groove 180, 182, each having an upward facing semicircular cross section.

The reference numerals 179a and 179b denote longitudinal guide walls for the insertion of opposite lateral faces of the portion 31a which bears the contact surface 31. The longitudinal walls 179a and 179b define, between them, means for the passage of the contact means, that is to say, a rear groove in the adapter.

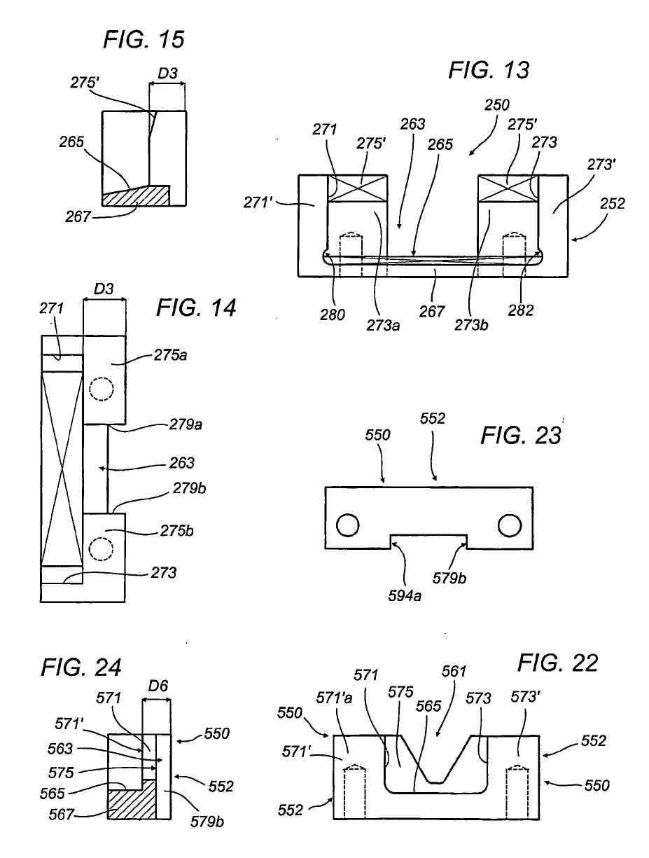

In a third preferred embodiment of the invention, illustrated in FIGS. 13 to 15, the adapter 250 comprises an abutting member 252 with a lateral and vertical abutting surface (271, 273) for each side portion of the shaped end 15 of the measuring instrument 11, these surfaces being defined by a first and a second side wall 271′, 273′.

The abutting member 252 further comprises a rear surface 275 abutting against the shaped end 15 of the measuring instrument 11, this rear surface being provided by a pair of rear walls 275a, 275b, separated by the gap 263 and being of defined thickness D3 such that the end 15 of the measuring instrument 11 yields elastically to them to a predetermined extent.

The rear walls 275a, 275b present a respective upper front surface 275′ that slopes towards the back of the adapter.

The abutting member 252 comprises a bottom surface 265 for supporting the shaped end 15 of the measuring instrument 11, this bottom surface being defined by a wall 267 being inclined in a forward direction, that is to say, downwardly from the rear wall of the abutting member 252.

This adapter 250 also comprises a bottom seat for supporting a respective lateral end portion of the shaped end 15 of the measuring instrument 11.

This consists of a first and a second lateral groove 280, 282 with semicircular cross section, extending along the base of the side walls 271 and 273, that is to say, at the edges of the bottom supporting surface.

The reference numerals 279a and 279b denote longitudinal guide walls for the insertion of opposite lateral faces of the portion 31a which bears the contact surface 31.

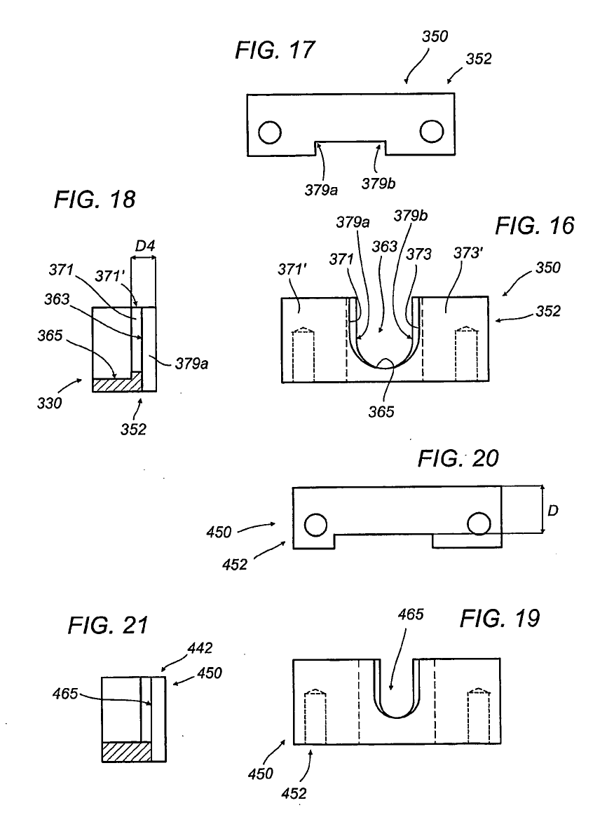

In a fourth preferred embodiment of the invention, illustrated in. FIGS. 16 to 18, the adapter 350 comprises an abutting member 352 with a lateral and vertical abutting surface 371, 373 for the side portions or faces of the shaped end 15 of the measuring instrument 11, these surfaces being defined by a first and a second side wall 371′, 373′.

This abutting member comprises a rear surface abutting against the shaped end 15 of the measuring instrument 11, this rear surface being provided by a pair of thin lips 371, 373 that define a groove 363 for the passage of the relatively narrow end of the measuring instrument.

Said rear wall has a defined thickness D4 such that the end 15 of the measuring instrument 11 yields elastically to it to a predetermined extent.

The abutting member 352 also comprises an upwardly curved bottom surface 365 for supporting the shaped end 15 of the measuring instrument 11. The reference numerals 379a and 379b denote longitudinal guide walls for the insertion of opposite lateral faces of the portion 31a which bears the contact surface 31.

In a fifth preferred embodiment of the invention, illustrated in FIGS. 19 to 21, the adapter 450 comprises an abutting member 452 that is very similar to the abutting member of the fourth preferred embodiment and therefore not described in detail. It differs in that the groove for the passage of the end of the measuring instrument is narrower than that of the adapter in the fourth embodiment and its upwardly curved bottom supporting surface 465 for the passage of the shaped end 15 of the measuring instrument 11 is therefore narrower than that of the fourth preferred embodiment.

In a sixth preferred embodiment of the invention, illustrated in FIGS. 22 to 24, relating to an instrument for measuring grooves, the adapter 550 comprises an abutting member 552 with a lateral and vertical abutting surface 571, 573 for each lateral face of the shaped end 15 of the measuring instrument 11, these surfaces being defined by a first and a second vertical side wall 571′, 573′.

The abutting member 552 comprises a rear surface abutting against the shaped end 15 of the measuring instrument 11, this rear surface being provided by a rear wall 575 of defined thickness D6 such that the end 15 of the measuring instrument 11 yields elastically to it to a predetermined extent.

The abutting member 552 comprises a flat, horizontal bottom surface 565 for supporting the shaped end 15 of the measuring instrument 11, this surface being provided by a thick, horizontal wall 567.

This adapter also comprises a groove 563 of substantially triangular shape, with downwardly converging walls, for the passage of the end of the instrument to e calibrated.

The reference numerals 579a and 579b denote longitudinal guide walls for the insertion of opposite lateral faces of the portion 31a which bears the contact surface 31.

In a preferred method for operating the calibrating device according to the invention, an adapter suitable for the instrument to be calibrated is fitted to the fixed block 14. Next, the measurement to be taken is set using a keyboard and the instrument is positioned with a shaped end on the fixed block and the other end on the mobile block.

At this point, the instrument can be calibrated by turning the graduated ring nut located on the instrument.

The preferred method also comprises a step of moving the mobile block backwards to the measurement start position and then returning to the defined calibrating position.

In an especially preferred calibrating method implemented by this device, the instrument calibration measurement, that is to say, the distance of the fixed and mobile contact surfaces from the references, is set by the control system to a value equal to the real calibration measurement plus an additional length, this additional length being calculated as the mean tolerance allowed for that specific calibration measurement.

This predetermined calibration distance is implemented for each instrument or type of instrument to be calibrated thanks to an appropriate control program residing in the control system memory.

In this way, calibrations are particularly accurate.

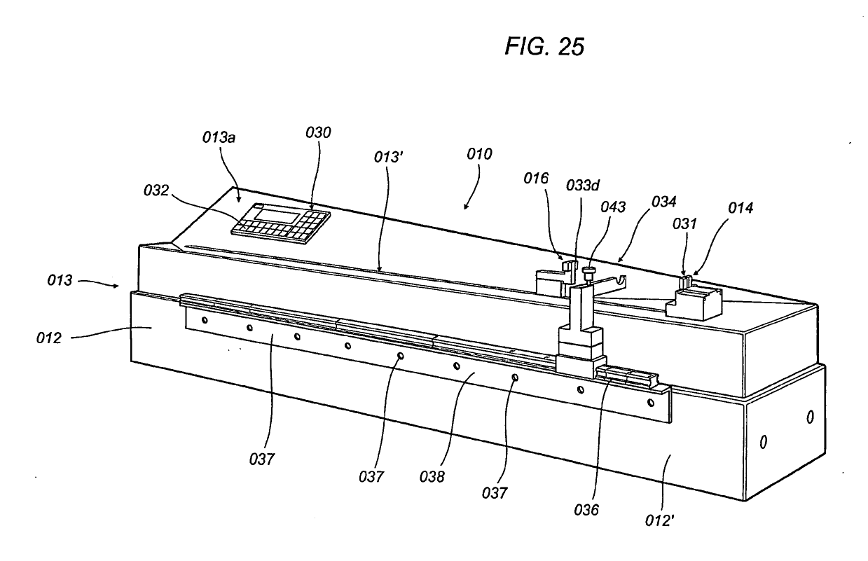

With reference to the accompanying drawings, an apparatus 010 according to this invention, in a second preferred embodiment of it, is used for calibrating measuring instruments, not illustrated in FIG. 25, such as bore gauges, groove gauges, precision feeler bore gauges, ID and OD micrometers, including stem type micrometers, precision ID and OD caliper gauges, mechanical and electronic contact plug gauges, as described in more detail below.

As is known, these measuring instruments have gauging ends that vary considerably according to the type, size and manufacturer of the measuring instrument.

The apparatus according to the invention comprises means for supporting the apparatus, consisting of a frame 013, which in turn comprises a cover 013a that is made from a shaped metal sheet and has a long transversal opening 013′ from which the contact heads extend out of the apparatus.

The cover 013a is of the type that rises on one side and is inclined forward slightly where there is a display unit, described in more detail below, for the apparatus control means, also described in more detail below.

As illustrated, the means for supporting the apparatus also comprise a relatively thick base plate 012, which is made preferably of granite.

The apparatus also comprises means for calibrating the measuring instrument.

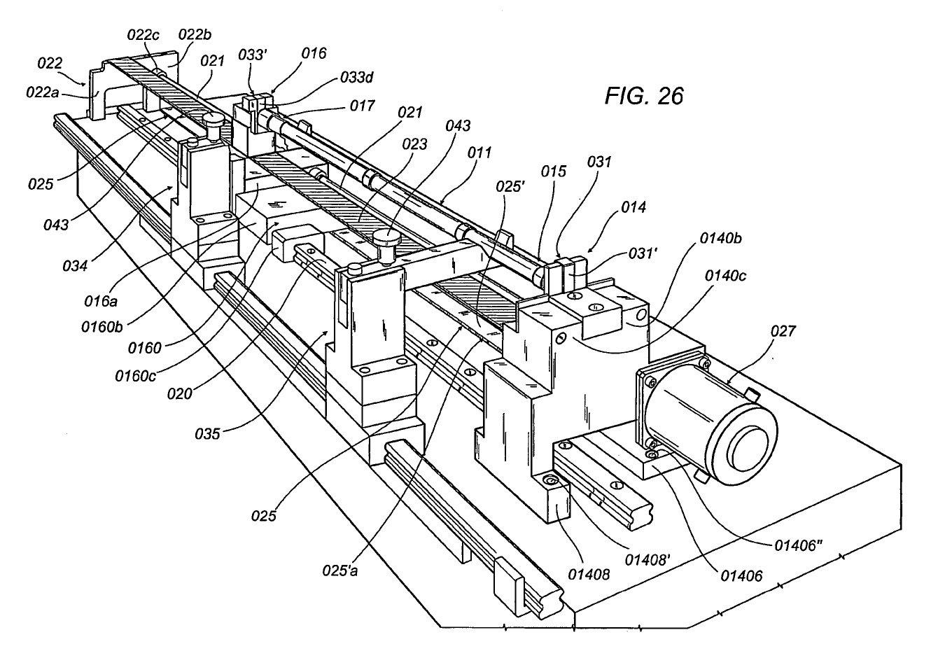

With reference also to FIG. 26, the calibrating means comprise means for coming into contact with a first gauging end 14 of the instrument 011 to be calibrated and a second gauging end 017 of the instrument 011 itself, these contact means being mobile relative to each other.

More specifically, the contact means comprise a fixed block 014 that is engaged by one end 015 of the measuring instrument and has a surface 031—made preferably of ceramic or other suitable material—for coming into contact with that end of the instrument, and a mobile block 016 that also has a contact surface 033, made preferably of ceramic or other suitable material, for the other end 017 of the measuring instrument.

As illustrated, the contact surfaces 031, 033 are positioned opposite each other. The respective elements that support or define the first contact surfaces 031, 033 support or define, at the longitudinally opposite end, corresponding second contact surfaces 031′, 033′, especially for calibrating an instrument for measuring outside diameters, as described in more detail below.

As illustrated, the contact surfaces of the fixed block 014 and of the mobile block 016 are aligned along a horizontal line running transversally to the apparatus, when viewed from the front.

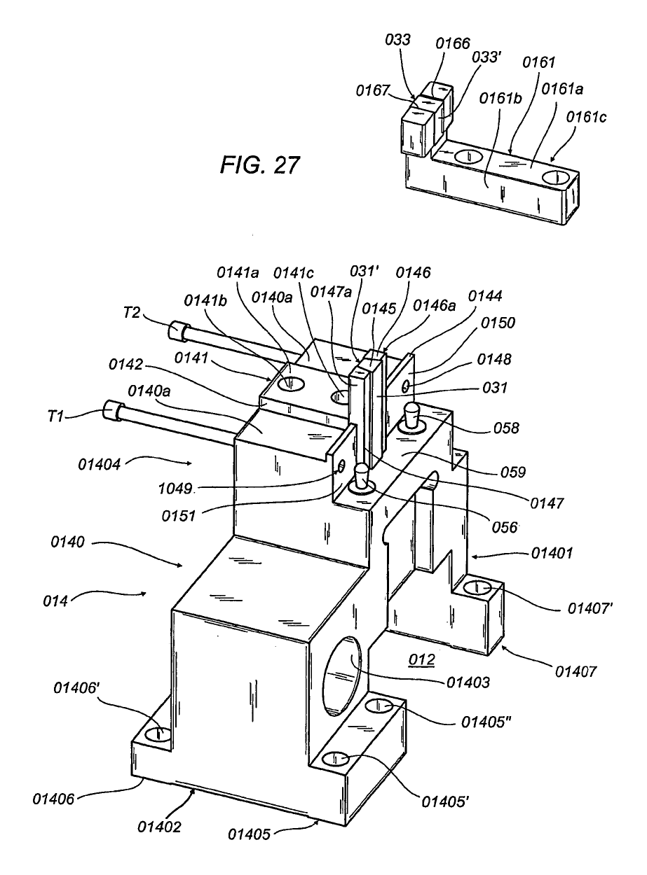

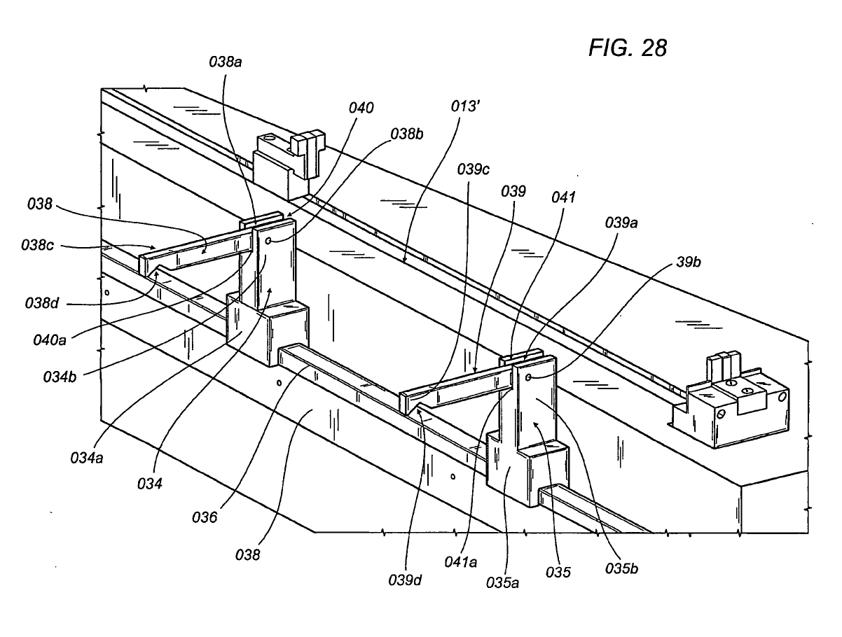

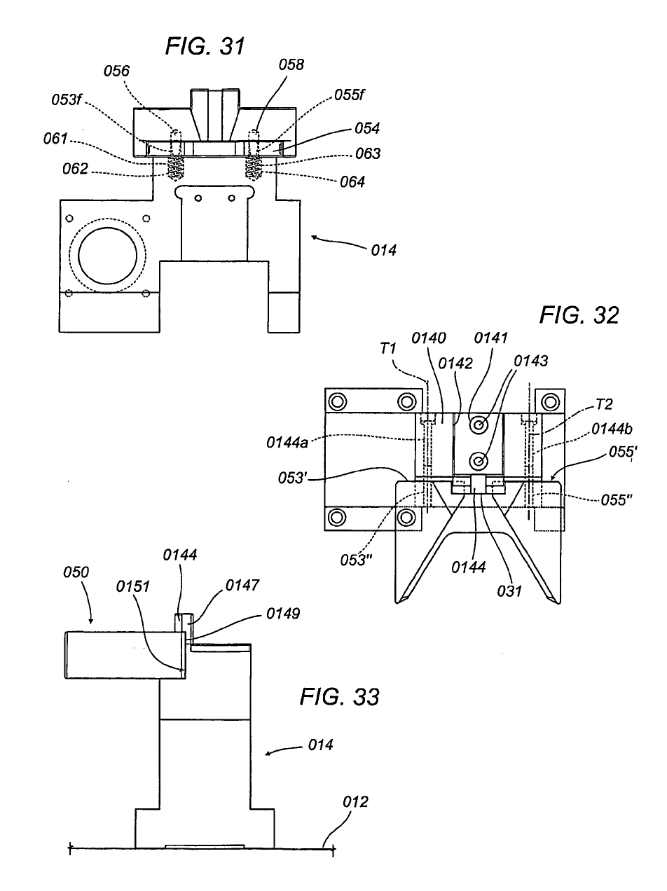

More specifically, as shown in FIG. 27, the fixed block 014 comprises an abutting member 0140 rigidly fixed to the granite base 012 and a contact element mounting body or block 0141 that is fitted in and retained by a long cavity 0142 made in the abutting member 0140. Screws (such as the ones labelled 0143 in the embodiment of the adapter illustrated in FIG. 32) are provided for fastening the mounting block 0141 to the abutting member 0140, these screws being inserted into matching holes 0141b, 0141c made in an upper flat rear surface 0141a of the mounting block 0141 protruding upwardly from the top surface 0140a of the fixed abutting member 0140.

The abutting member 0140 has a portal frame structure with a first, narrow column 01401 and a second, wider column 01402 having a longitudinal through hole 01403 made in it for the passage of a motor drive shaft supported by this column 01402.

Looking at it in its entirety, the fixed abutting member

0140 has a step-shaped upper section with an upright having a substantially square-shaped base, on which there is positioned a mounting block 0141 for the contact means, as described in more detail below, and which acts as a retaining element for a tape that closes the transversal opening through which the contact elements extend outside the apparatus.

In order to create a particularly rigid portal frame structure, the columns have longitudinal wings or extensions protruding from them, the ones on the column 01402 being labelled 01405 and 01406, and the ones on the narrow column 01401 being labelled 01407 and 01408.

These extensions have respective holes 01405′, 01405″, 01406′, 01406″, 01407′ and 01408′ for respective screws to be inserted into the granite base. Thus, the structure of the fixed block is particularly rigid and resistant.

The ceramic surface 031 is made at the end of a prismatic insert 0144 with a quadrangular base held within a groove 0145 made between two perpendicular walls 0146, 0147 of the shaped metal mounting block 0141, protruding from the front of it. At the front of and lower down than the side walls 0146, 0147 there are plates 0148, 0149, that are thinner than the side walls 0146, 0147 and form respective front surfaces 0150, 0151 for engaging the rear surface of the adapter means, as described in more detail below.

The side walls 0146, 0147 define a longitudinal lateral surface 0146a, 0147a for guiding or centring the respective surfaces of the adapter.

The means for connecting the adapter to the head 014 comprise, on the head 014, a first and a second pin 056, 058 to be inserted into matching holes and protruding from a corresponding horizontal flat surface 059 for supporting the bottom surface of the adapter.

Means are also provided for retaining the adapter body, these means being in the form of spring means designed to push the adapter towards and against opposite vertical surfaces 0150, 051 of the fixed block 014.

The spring pushing means comprise springs 061, 063, each supporting a respective insertion pin 056, 058 and being oriented vertically and housed in respective vertical holes 062, 064 made in the fixed block 014, as shown in FIG. 31.

At an upper end of the middle, offset upright 0144, the fixed block also comprises a first and a second through hole 0144a and 0144b, which extend horizontally between the rear faces 0140b, 0140c and the front faces 0150, 0151 of the abutting member 0140.

The holes 0144a and 0144b are designed to receive respective screws T1 and T2 for holding the back of an adapter, as described below, so as to provide additional means for locking and securely retaining the adapter in the working position. These locking means are especially advantageous for holding relatively long or protruding adapters.

The mobile block 016 in turn comprises a transversally mobile abutting member 0160 and a contact element mounting body or block 0161 that is fitted in and retained by a long cavity 0162 made in the abutting member 0160. Screws are provided to hold the block 0161 to the lower mobile guide abutting member 0160 and are inserted into matching vertical holes 0163a, 0165a made in a rear, flat top surface 0161a of the block 0161.

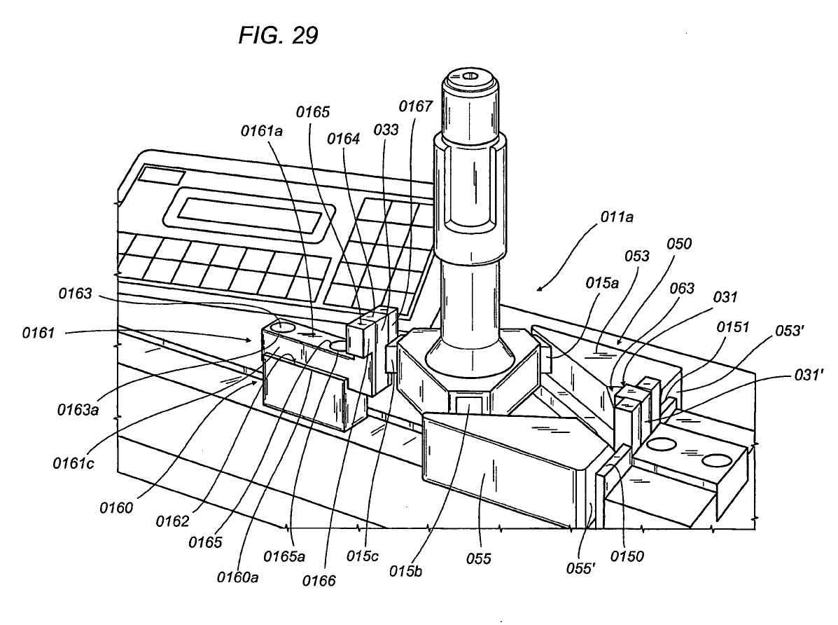

As illustrated in FIGS. 27 and 29, the contact means mounting block 0161 extends upwards and comprises a first and a second vertical lateral surface 0161b, 0161c held between a first and a second longitudinal wall (only one of which, labelled 0160a, being illustrated in FIG. 29) of the abutting member 0160.

The abutting member 0160 comprises a stout central portion 0160b forming longitudinal extensions (only one of which, labelled 0160c, being illustrated in FIG. 26) that run on the lower guide track 020 of the mobile block.

More specifically, the ceramic surface 033 is made at the end of a prismatic insert 0164 with a substantially rectangular base held within a groove made between two perpendicular walls 0166, 0167 of the shaped metal mounting block 0161.

Means are also provided for driving the mobile block.

The means for driving the mobile block comprise mobile block guiding means that comprise a rod 020, of generally quadrangular cross section, extending transversally between the fixed block 014 and an opposite fixed block 022.

More particularly, the second fixed block 022 comprises an abutting member rigidly fixed to the granite base and also having a portal frame structure with a first, narrow column 022a and a second, wider column 022b having a longitudinal through hole 022c made in it for the passage of suitable means for supporting the end of the drive shaft opposite that protruding from the electrical control motor.

The lower end 016a of the mobile block, which has a matching quadrangular profile, runs on the guide rod 020.

As explained in more detail below, the shaft that drives the mobile block 016 backwards and forwards is, advantageously, vertically aligned and parallel with a rod 025′ of quadrangular cross section, extending transversally between the fixed block 014 and an opposite fixed block 022 bearing a graduated measuring rod or rule 025.

This arrangement of the drive shaft makes it possible to obtain a more accurate calibration.

The mobile block drive means also comprise means for feeding the mobile block itself which in turn comprise a rotary shaft 021, of circular cross section, that is parallel with and longitudinally spaced from the guide rod 020 fixed to the base plate and that also extends transversally between the fixed block 014 and the opposite fixed block 022.

On the rotary shaft 021 there operates an instant locking feed mechanism, housed in the head 016 and not illustrated in detail in the accompanying drawings, which, by rotating the shaft, advances the slider 016, and stops the slider 016 in the desired position to a great degree of precision as soon as the shaft is stopped. Obviously, any other device suited to the purpose might also be used.

The mobile head is driven lengthways to the guide rod 020 by a motor 027 which rotationally drives the shaft 021, said motor being mounted, as illustrated, on the fixed head 014.

The drive shaft 021 is firmly connected to the fixed head 014 by a ring nut acting on a respective bearing in the through hole for the shaft, while, at the opposite end, that is, at the fixed block 022, the shaft 021 is held solely by a bearing housed in a large through hole relative to which it is free to move slightly owing to the expansion of the rod.

There is also provided a tape 023 which closes the groove 013′ when the mobile block moves. The tape 023 is fitted between the fixed heads 014 and 022 and is appropriately connected to the mobile head 016.

In practice, the tape has a first end that is fixed securely, for example by a pair of rivets, to the fixed contact head 014, and a second end that is fixed securely, for example by a pair of rivets, to the fixed head 022, opposite the fixed contact head 0144.

In practice, the tape runs on a first pair of rollers forming part of the mobile head 016 and on a similar second pair of rollers forming part of the mobile head 016, these rollers not being illustrated in detail in the accompanying drawings.

Control or processing means are also provided. These means comprise a CPU, a memory unit, a display unit 030, a keyboard 032 and CPU signal input/output means.

Means are also provided for determining the calibration measurement.

The means for determining the calibration measurement comprise means for detecting the position of the mobile block 016, said means comprising a sensor, preferably optical, mounted on the mobile block 016, and a graduated rod 025 supported by the base plate 012 in front of the means for driving the mobile block 016.

The optical sensor is directed at the graduated rod, or means for determining the calibration measurement, and sends corresponding signals when it passes by the millimetre marks on the graduated rod.

As illustrated, the graduated rod 025, which, for example, might by a rule manufactured by RENISHAW or HEIDENHAI, extends transversally and lies in a vertical plane since it is fixed, firmly on the side facing the block 014 and in such a way that it can extend freely on the side of the block 022, to a vertical face of the supporting rod 025′, fixed to the granite base 012, and more particularly, to the vertical face 025′a facing inwards, that is to say, facing the mobile block 016 where there are suitable reading or detecting means.

In this way, dirt or other extraneous matter that finds its way into the apparatus does not settle on the rule 025 and cannot upset the measuring operation.

The apparatus also comprises suitable intermediate means for supporting long measuring instruments, said intermediate supporting means 034, 035, being positioned between the fixed head 014 and the mobile head 016 to provide intermediate support for a stem-type instrument, for example an ID stem-type micrometer.

These intermediate means for supporting long measuring instruments between the first and second heads comprise at least one portion that is mobile between a position where the instrument is supported and a retracted rest position where they do not interfere with the calibrating means.

Advantageously, these intermediate supporting are permanently fixed to the apparatus supporting means, as will become more evident below, and consist of one or more supporting elements, and, more particularly, a first and a second intermediate supporting element 034 and 035.

A different, larger number of intermediate supporting elements might also be imagined.

These supporting means are connected to the apparatus in a mobile manner so that they can be freely positioned transversally in the most suitable position between the heads 014 and 016 and can, when necessary, be moved outside the working area so as not to interfere with calibrating or other operations.

The intermediate supporting elements are slidably supported on a supporting guide strip 36 fixed to an “L” shaped profile 038 that extends transversally at the bottom and that is fixed to the granite base 012, and, more particularly, to the transversal lateral face 012 of the base, that is, to the front vertical face, through respective screws inserted into holes 037.

The intermediate supporting elements comprise a lower body or block 034a, 035a, whose underside is especially shaped to slide on the supporting track or strip 036, and a prismatic column portion 034b, 035b, that extends upwards and presents a longitudinal groove 040, 041 in which one end 038a, 039a of a corresponding instrument mounting arm 038, 039 is inserted, this arm being held in the groove by a suitable rotation pin 038b, 039b.

The groove has a bottom 040a, 041a for delimiting the forward and backward rotation of the arm 038, 039. A screw 043 is used to adjust rotation, that is to say, the supporting height.

The adjustable arm 038, 039 also has a free end 038c, 039c having a shaped or recessed portion 038d, 039d at a top surface of it which, during use, forms a seat for receiving a respective portion of the measuring instrument.

As described above, the intermediate supporting means, when they are not used, can advantageously kept in a non-supporting condition without interfering with other calibrating operations.

There is also provided an adapter element 050 positioned on the fixed block 014 and used to position on the device a respective measuring instrument, in particular, an ID micrometer 011a having three sensing ends 015a, 015b and 015c at angular intervals of 120°from each other.

This seventh adapter embodiment 050 consists of a single body that defines a respective contact surface and, more particularly, a first and a second contact -surface defined by angularly spaced surfaces.

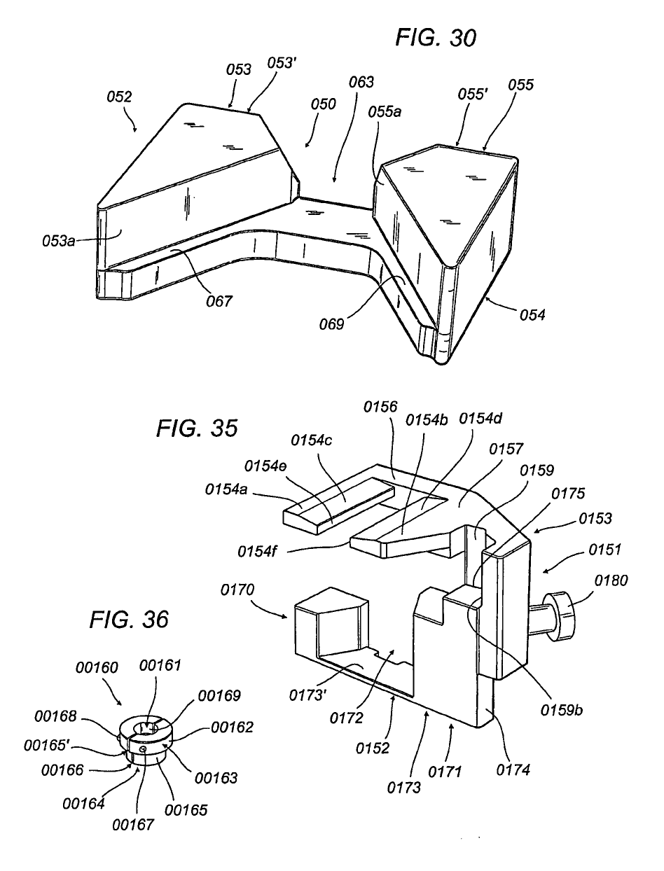

As illustrated in FIGS. 29 to 33, the adapter element 050 comprises an abutting member 052 constituting means for supporting a first and a second sensing end 015a and 015b of the measuring instrument 011a, while the other sensing end 015c simply abuts against the mobile contact block 033.

As shown in the illustrations, the abutting member 052 of the adapter 050, made of a suitable metal, comprises a groove 063 that opens onto the back of it and divides it into a first and a second separate side portion 053, 055, each being essentially in the shape of a triangle or wedge.

In this seventh adapter embodiment 050, the ends 015a and 015b of the measuring instrument 011a do not extend towards and against the contact surface 031 of the fixed block 014.

Instead, the ends 015a, 015b come into contact with the corresponding opposite vertical surfaces 053a, 055a on the inside of the side portions 053, 055 of the adapter.

The vertical surfaces 053a, 055a are angularly spaced by 60°.

Means are also provided for connecting the adapter 050 to the fixed block.

The means for connecting the adapter 050 to the mounting block 14 comprise a first and a second hole 053f, 055f that open onto a lower horizontal flat surface 054 of the abutting member 052 and receive the first and second pins 056, 058 which, as described above, are equipped with spring means for pushing the abutting member 052 towards and against an opposite vertical surface 0150, 0151 of the fixed block 014.

The abutting member 052 also comprises a rear surface 053′, 055′ abutting against the front surface of the fixed block and having respective threaded holes 053″, 055″ for screws T1 and T2 constituting means for securely holding the adapter 050 to the fixed unit 014.

The dimensions of the adapter are predetermined and known to the processing means of the apparatus according to the invention. The system therefore knows the real distance between the mobile contact element 033 and the vertical surfaces 053a, 055a.

The abutting member 052 also comprises a narrow bottom surface 065 for supporting the shaped end 015a, 015 of the measuring instrument 11.

More specifically, the adapter 050 comprises a first and a second horizontal surface 067, 069 forming a step that protrudes from the bottom of the contact surfaces 053a, 055a.

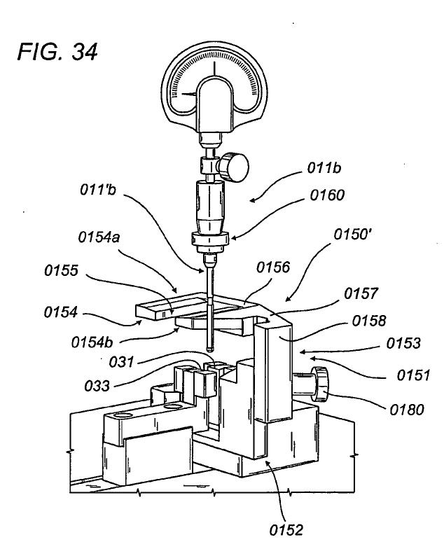

FIGS. 34 to 36 illustrate an eighth preferred adapter embodiment, labelled 0150′ in FIG. 34.

This eighth preferred adapter embodiment 0150′ is particularly suitable for supporting precision feeler bore gauges, like the one labelled 011b in FIG. 34, which have very small sensing tips, as may be inferred from the fact that the contact surfaces 031 and 033 are very close to each other.

This eighth adapter consists of a first element 0151, having a fixed bottom portion 0152, that is rested with the holes (not shown in the drawings) made in its bottom surface 0173, into which the aforementioned fixed head spring retaining pins 056, 058 are inserted, and that is further retained, in a manner similar to that of the seventh adapter described above, by the rear fastening screws T1 and T2 which are inserted into the rear surface of the columns 0170, 0171 of the fixed portion 0152, as described in detail below.

The fixed bottom portion 0152 supports a vertically mobile top portion 0153 in order to adapt the height of the supporting portion of the instrument to the different lengths of the stems 11′b of the respective precision bore gauge.

The mobile top portion 0153 has a forked portion 0154 with a first and a second substantially horizontal leg 0154a, 0154b forming a gap for the passage of the stem 011′ b of the bore gauge 011b towards the calibrating area.

As illustrated, the legs 0154a, 0154b extend from a rear portion 0156 having a top flat surface lying in the same plane as a vertical lateral surface 0157 of a bottom supporting portion 0158 of the mobile element 0153.

This adapter further comprises an annular element 00160 constituting an element for supporting matching, downwardly converging inclined surfaces lying on the inside of the top surfaces of the legs 0154a and 0154b, said surfaces being labelled 0154c and 0154d in the accompanying drawings.

The instrument supporting element 00160 has a vertical through hole 00161 by which the instrument is placed on the stem 011′ b of the instrument, and an upper enlarged crown portion 0162, constituting a bottom surface 00163 for supporting the surfaces 0154c and 0154b of the fixed adapter element 0151.

The adapter element 00160 also comprises an extension sleeve 00164, having an outer surface 00165, designed to come into contact with the opposite inside vertical surfaces 0154e and 0154f of the longitudinal legs 0154a, 0154b.

The outer cylindrical surface of the sleeve 00164 is joined to the outer surface of the ring 00162 by a spherical or curved profile 00165′ which facilitates manual positioning, by the user, of the instrument to be calibrated.

As shown in FIG. 35, the vertical surfaces 0154e and 0154f are parallel to each other and perpendicular to the rear portion 0156. This configuration enables the adapter element 00160 to be conveniently supported with the stem 011′b in the vertical condition.

As illustrated in FIG. 36, the element 00160 has a vertical groove 00166 and a horizontal hole made in the top annular element 00162, the hole being labelled 00167 and extending on the parts of the annular element 00162 that lie on both sides of the vertical groove 00166.

A screw 00168 is inserted into the threaded hole 00167 in such manner as to reduce the diameter of the inside surface 00169 of the adapter 00160 which can therefore firmly hold the instrument 011b at an appropriate portion.

In this way, the adapter element 00160 can be freely adjusted to the shapes of different precision bore gauges. This provides an adapter system that can be adjusted to a plurality of measuring instruments and is therefore extremely flexible.

As stated above, the reference numeral 0152 denotes a fixed portion of this adapter. This fixed portion consists of a first and a second side portion 0170 and 0171, between which there is an opening, labelled 0172 in its entirety, providing a passage for and access to the fixed contact surface 031.

As illustrated, the side element 0171 of the adapter 0151 is higher and comprises an outer lateral surface 0174 and a rear surface 0175, which cooperate with corresponding opposite surfaces 0159a and 0159b of the mobile element 0153, which are at right angles to each other.

In practice, between the surfaces 0174 and 0175 of the side column 0171 and the front and side surfaces 0159a and 0159b there are provided opposite sliding guide strips, not illustrated in detail in the drawings, which allow the top body 0153 to move freely in the vertical direction relative to the lower body 0152. The numeral 0180 denotes a knob for actuating a pin that locks the vertical movement of the upper adapter 0153 relative to the fixed lower body 0152, this pin having a front end that cooperates with an opposite surface of the fixed body 0152. This pin and the engagement surface are not illustrated in detail in the accompanying drawings.

The numeral 0173′ denotes a lower crosspiece connecting the side columns 0170, 0171 of the fixed body 0152.

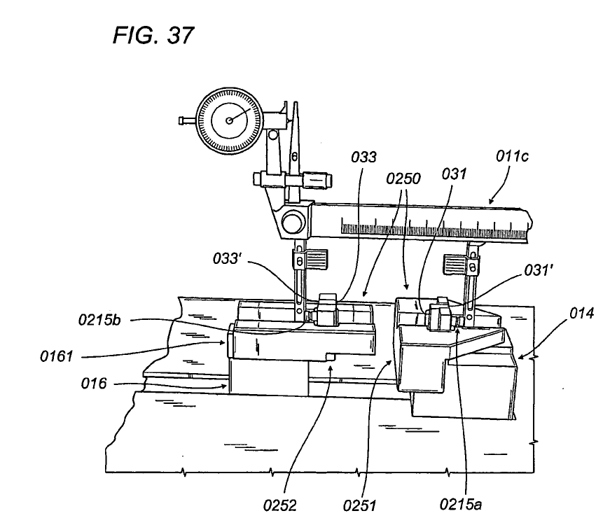

FIGS. 37, 38 and 39 illustrate a ninth preferred adapter embodiment.

This ninth preferred embodiment 0250 of the adapter, like the second preferred embodiment, is a composite adapter.

More specifically, this composite adapter 0250 comprises a first adapter element 0251, associable with the contact surface 031 on the fixed head, and a second adapter element 0252, associable with the contact surface 033 on the mobile head.

Thus, both the inside contact surfaces 031, 033 and the outside surfaces, labelled 031′ and 033′ in FIG. 37, in the respective ceramic portions, can be used for calibrating precision ID or OD gauges.

In practice, in addition to the distance between the opposite contact surfaces 031, 033 on the fixed and mobile heads, respectively, the processing means that control the apparatus according to the invention also know the distance between the vertical outside or rear surfaces 031′ and 033′ of the ceramic contact portions of the fixed head 014 and of the mobile head 016.

As illustrated, these rear contact surfaces 031′ and 033′ protrude outwards from the back of the side walls that have the ceramic contact surfaces, as stated above.

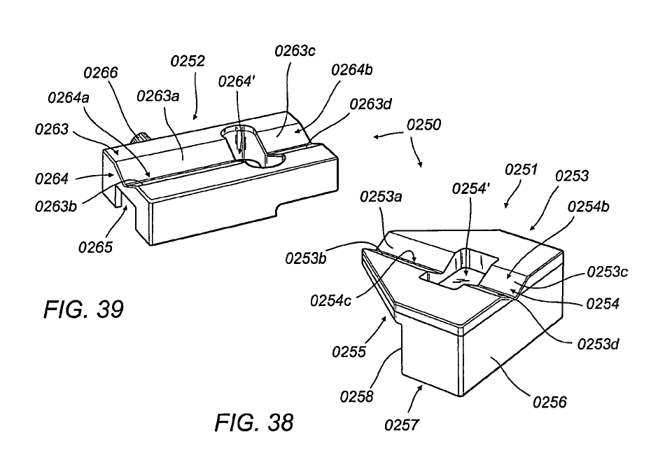

As shown in particular in FIGS. 37 and 38, a first adapter element 0251 comprises a top surface 0253 with a central hole 0254′ which is essentially rectangular in shape and which, as may be inferred in particular in FIG. 37, allows the contact elements and the means that support them to protrude upwards through the surface 0253.

The top surface 0253 of the element 0251, which is connected to or mounted on the fixed head 014, has a longitudinal channel 0254 that extends on both the front and back of the contact element and is formed by flat, downwardly converging, inclined rear surfaces, upstream of the contact element, labelled 0253a and 0253b in FIG. 38, and by a pair of converging, inclined front surfaces, downstream of the contact element, labelled 0253c and 0253d in FIG. 38.

As illustrated in FIG. 37, the rear portion 0254b of the channel 0254, in the given contact position, is designed to accommodate and guide a sensing end 0215a of an OD gauge 011c so that the sensing end 0215a abuts against rear contact portion 031′ of the fixed head 014.

Similarly, an ID gauge might be calibrated using the front channel 0254a to guide a corresponding sensing end of the measuring instrument so that it abuts against the front contact surface 031 of the head 014.

As illustrated in FIGS. 37 and 38, the top portion 0253 consists of a thick plate whose bottom surface 0255 rests on the top surface 0141a of the block that mounts the contact means.

The first adapter element 0251 is completed by a bottom block 0256 that supports the top block 0253.

This bottom block 0256 has vertical holes (not illustrated in the drawings) that extend from its bottom surface 0257 and receive the retaining pins 056, 058 provided on the fixed head 014, these locating pins 056, 058 pushing the rear face 0258 of the block 0256 against the vertical abutting face 0151, 0150 of the fixed head 014.

FIG. 39 shows the second adapter element 0252 of the composite adapter, this second element being designed to be positioned on the mobile head 016. This second adapter element 0252 has a central, substantially quadrangular hole 0264′ for the passage of the element that supports the contact surfaces 033, 033′, as may be inferred from FIG. 39, and comprises a top surface 0263, which defines a central, longitudinal channel 0264, having a front or downstream part 0264b and a rear or upstream part 0264a, these two parts of the channel being defined by parallel surfaces, the rear part 0264 by inclined surfaces 0263a, 0263b, and the front part 0264b by flat inclined surfaces 0263c and 0263b.

The channel has a defined triangular cross section and its rear part 0264a is designed to guide a sensing end 0215b of the OD precision gauge so that it abuts against the rear contact surface 033′ of the mobile head, as shown in FIG. 37.

In the same way, the inside or front part 0264b of the channel supports a corresponding sensing end of an ID precision gauge.

To enable the top portion of the mobile head 016 to support the second adapter element 0252, the second adapter element 0252 has a rear opening 0265 and a shaped inside surface adapted to abut against the top surface of the block that mounts the contact means, and corresponding vertical surfaces, not illustrated in detail in FIGS. 37 and 39, for abutting against the lateral surfaces 0161b, 0161c of the block that mounts the mobile contact means 016 (the lateral surfaces 0161b, 0161c of the block 0161 being shown in FIG. 27).

The reference numeral 0266 denotes a side knob for pushing the tip of a contact pin against the opposite lateral surface 0161b of the block 0161 that supports the contact means of the mobile head 016, so as to securely lock the second adapter element 0252 to the top of the mobile head 016.

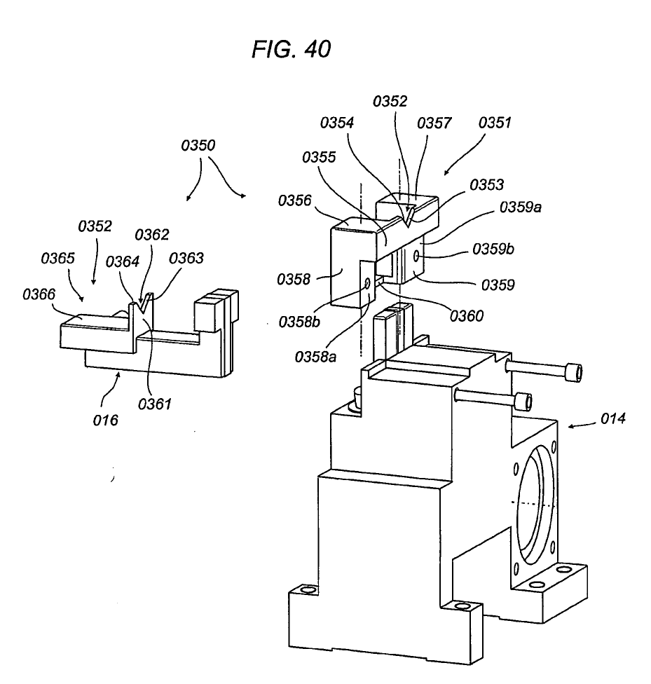

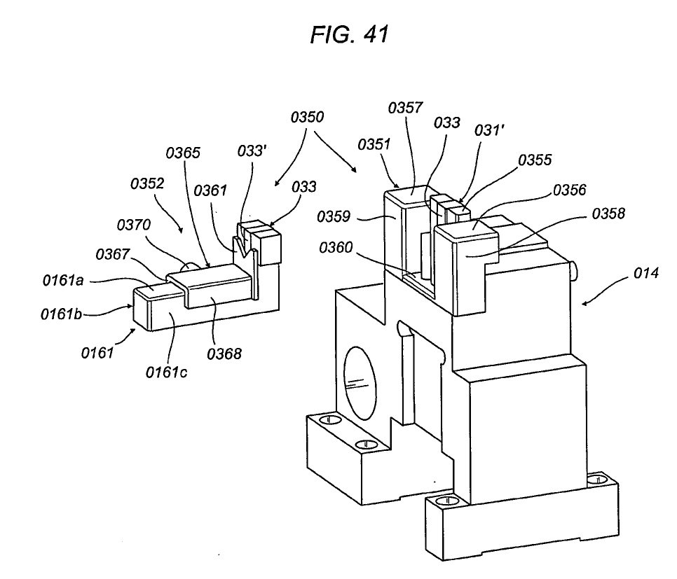

FIGS. 40 and 41 illustrate a tenth preferred adapter embodiment, labelled 0350.

The tenth preferred adapter embodiment is also a composite adapter, comprising a first adapter element 0351, associated with the fixed head 014, and a second adapter element 0352 associated with the mobile head 016, and is especially suitable for OD/ID micrometers.

As may be inferred from FIGS. 40 and 41, the first adapter element 0351 comprises a portion for guiding the corresponding sensing end of the measuring instrument, this portion being defined, as shown in FIG. 40, by a groove 0352 formed by two inclined converging surfaces 0353, 0354, in a vertical plate 0355 which, during use, is positioned at the back of the contact means, as shown in particular in FIG. 41.

In practice, the sensing end is rested against the triangular groove 0352 and comes into contact with the rear contact surface 031′ of the fixed head 014.

The first adapter element 0351 comprises a pair of parallel longitudinal elements 0356, 0357 that support the plate 0355 at their rear ends.

Extending from the front, bottom part of the longitudinal elements 0356, 0357 there are uprights 0358, 0359 with holes at the bottom of them, for the insertion of the retaining spring pins 056, 058 provided on the fixed head 014, as in the other embodiments of the adapter, described above.

With their rear surfaces 0358a, 0359a said uprights come into contact with the vertical abutting faces 0150, 0151 of the fixed head 014. These rear surfaces 0358a 0359a have respective holes 0358b 0359b into which the fastening screws T1 e T2 are inserted to provide additional means for locking the adapter to the fixed head 014, as in the other embodiments of the adapter, described above.

The reference numeral 0360 denotes a bottom strip connecting the bottom surfaces of the uprights 0358, 0359.

The reference numeral 0352 in FIGS. 40 and 41 denotes a second adapter element associated to the mobile head 016, for ID/OD micrometers.

As illustrated, the adapter element 0352 comprises a vertical plate 0361 that defines a triangular or dovetail groove 0362 formed by downwardly converging opposite surfaces 0363, 0364, said groove 0362 constituting an abutting portion for a sensing end of a micrometer or other measuring instrument, which abuts against the upstream or rear contact surface 033′ of the mobile calibrating element 016.

In order to support the plate 0361 at the rear part 033′ of the contact means on the mobile head 016, the second element 0352 has a “C” shaped longitudinal profile 0365 having an upper wing 0366 abutting against the rear top surface 0161a of the contact element mounting block and respective lateral wings 0367, 0368 placed in parallel over the vertical surfaces 0161b, 0161c contact element mounting block 0161.

The means for locking the second adapter element 0352 to the fixed head comprise a suitable pin, whose end comes into contact the corresponding lateral surface 0161b contact element mounting block and which is actuated by the knob 0370. The lock pin actuated by the knob 0370 is not shown in FIGS. 40 and 41.

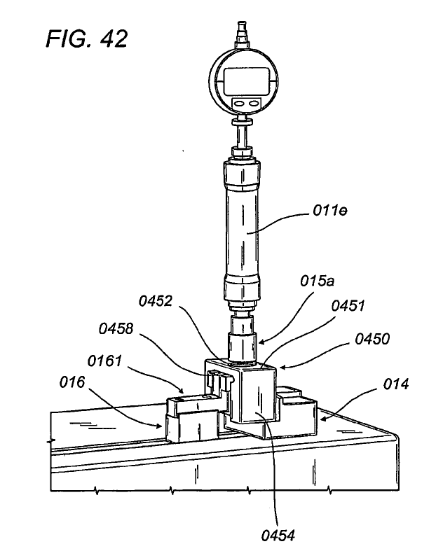

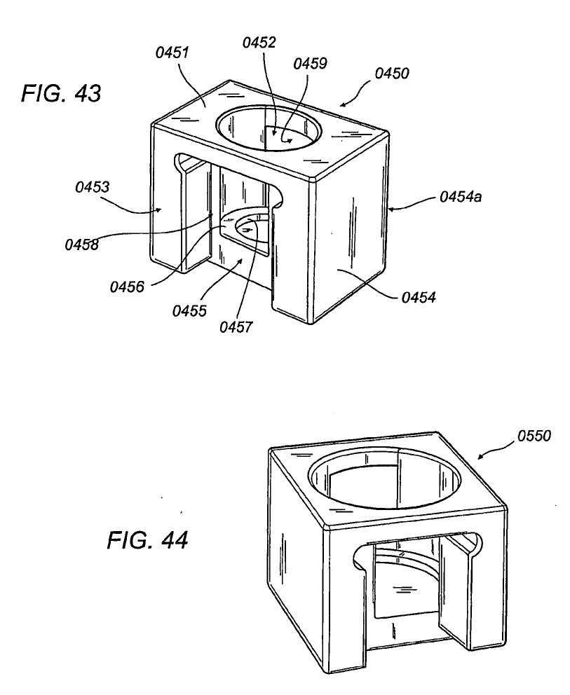

An eleventh preferred adapter embodiment is illustrated in FIGS. 42 and 43.

This adapter, labelled 0450, is especially suitable for mechanical and electronic contact plug gauges like the one labelled 011e in FIG. 42. This type of measuring instrument has a circular sensing head, labelled 015a in FIG. 42.

As shown in particular in FIG. 43, the adapter 0450 consists of a single body having a top plate 0451, in which there is a central, circular hole 0452 for the passage of the bottom end of the measuring instrument 011e.

As illustrated in FIG. 43, the element 0450 also comprises a first and a second side column, labelled 0453 and 0454, connected at their lower ends by a bottom portion, consisting of a plate 0455, whose front longitudinal edge 0455a is recessed with respect to the front longitudinal faces of the columns 0453, 0454. Similarly, on the opposite side, the rear longitudinal edge of the plate 0455 (not illustrated in detail in the drawings) is recessed with respect to the rear longitudinal faces (only one of which, labelled 0454a, is shown in FIG. 43) of the columns 0453, 0454.

The bottom 0455 has a top surface 0456 with a circular hole 0457 for receiving the lower end 015a of the instrument 011e.

As shown in FIGS. 42 and 43, the adapter element 0450 is open on both longitudinal sides and has a front opening 0458 for the passage, as may be easily inferred from FIG. 42, of the mobile contact element 033 towards a corresponding abutting surface of the lower end 015a of the instrument. The adapter element 0450 also comprises a rear opening 0459 for insertion towards the corresponding lower end 015a of the instrument 011e to be calibrated (on the side opposite the portion that is in contact with the mobile contact surface 033) abutting against the contact surface 031 on the fixed head 014, as may be easily inferred from FIGS. 42 and 43.

The adapter element 0450 is connected to the fixed head thanks to a pair of holes made in its bottom surface for receiving the aforementioned spring pins 056, 058, and thanks to the fact that the fastening screws T1 and T2 are inserted from the back into the rear walls 0454a of the upright 0454 and into the rear wall (not shown in the drawings) of the corresponding upright 0453, in substantially the same way as the other embodiments described above.

FIG. 44 shows a twelfth preferred adapter labelled 0550 in its entirety that is substantially the same as the eleventh adapter 0450 but larger in size so that it can be used for a contact plug gauge differing in size from the one illustrated.

A plurality of these adapters can therefore be used, each one suitable for receiving a respective plug gauge, thus conferring considerable versatility on the apparatus according to the invention for calibrating measuring instruments.

In a preferred method for operating the calibrating device according to the invention, an adapter suitable for the instrument to be calibrated is fitted to the fixed block 014. Next, the measurement to be taken is set using a keyboard and the instrument is positioned with a shaped end on the fixed block and the other end on the mobile block.

At this point, the instrument can be calibrated by turning the graduated ring nut located on the instrument.

The preferred method also comprises a step of moving the mobile block backwards to the measurement start position and then returning to the defined calibrating position.

In an especially preferred calibrating method implemented by this device, the instrument calibration measurement, that is to say, the distance of the fixed and mobile contact surfaces from the references, is set by the control system to a value equal to the real calibration measurement plus an additional length, this additional length being calculated as the mean tolerance allowed for that specific calibration measurement.

This predetermined calibration distance is implemented for each instrument or type of instrument to be calibrated thanks to an appropriate control program residing in the control system memory.

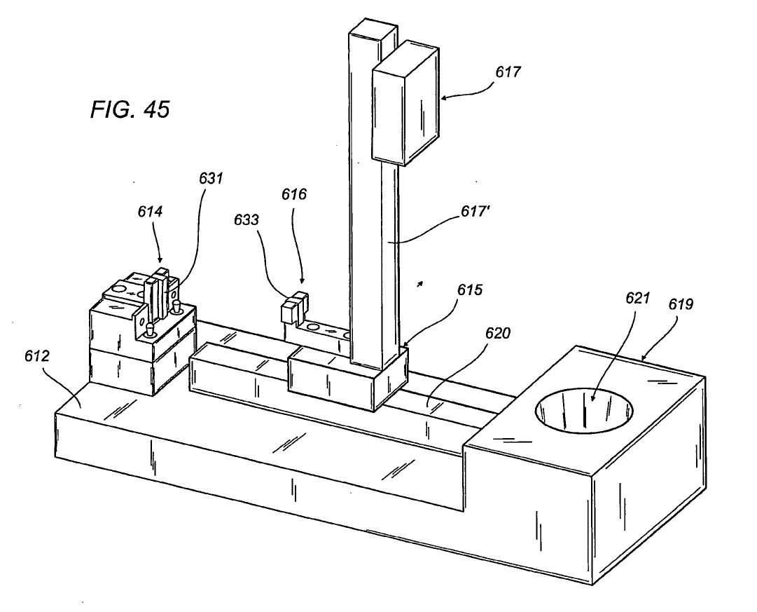

A third embodiment of the calibrating apparatus is illustrated in FIG. 45. The embodiment of the apparatus illustrated in FIG. 45 comprises a long base plate 612, made preferably of granite, a fixed head 614 having a contact surface 631 and a mobile head having a contact surface 633, for respective ends of measuring instruments to be calibrated. The fixed and mobile heads 614 and 616 are substantially the same as those described for the other embodiments and are not therefore described in detail again.

Advantageously, in this embodiment of the apparatus, the base plate 612 also mounts pre-recording means for a tool of a machine tool.

This provides a compact, multipurpose apparatus.

The tool pre-recording means comprise a mobile target 617 and a fixed seat 621 for accommodating the tool. More specifically, the seat 621 for accommodating and supporting the tool to be pre-recorded, not illustrated in the drawings, has a fixed supporting base 619 at one end of the base plate 612.

The apparatus further comprises a mobile head 616 that mounts the mobile pre-recording target 617 of a tool on a machine tool.

There is a single mounting body 615 that is slidably supported on a guide rod 620, with a quadrangular base, that mounts both the pre-recording target 617 and the mobile contact element 633 for calibrating a measuring instrument.

As illustrated, the target 617 is mounted on a column 617′ and extends from the mobile body 615 on the side opposite the mobile contact element 633.

The pre-recording means operate on a tool such as a lathe in a manner well known to an expert in the trade and are not therefore described in further detail.

Means are provided for driving the mobile block, these drive means comprising means for feeding the mobile block, such as, for example, a rotary shaft of circular cross section positioned, as in the second preferred embodiment of the apparatus, parallel to, and vertically offset from, the guide rod 620 fixed to the base plate and that also extends transversally between the fixed block 614 and the opposite fixed block 619. This guide rod is not illustrated in detail in FIG. 45.

The means for determining the calibration measurement comprise means for detecting the position on the mobile block 615, which in turn comprise a sensor, preferably optical, mounted on the mobile block 615 and a graduated rod (not illustrated in the drawings) supported by the base plate 612 in front of the guide rod 620 of the mobile block 615, as in the preceding preferred embodiment.

The graduated rod extends for the full distance between the fixed heads 614 and 619, in the same way as the rod extending between the heads 014 and 022 in the preceding preferred embodiment. In this third embodiment, however, the graduated rod advantageously constitutes measuring means for both the calibrating means and the tool pre-recording means.

The single sensor located on the single mobile body 615 for the mobile calibrating head 616 and for the pre-recording target 617, is directed at the graduated rod, or similar measuring means, and sends corresponding signals when it passes by the millimetre marks on the graduated rod. These signals are appropriately processed by the control means of the apparatus in order to calibrate a measuring instrument or pre-record a tool, as the case may be.

As shown in FIG. 45, the fixed head 614 for the contact element 631, for calibrating a measuring instrument is advantageously provided at the end opposite the seat 621 for pre-recording a tool.

It will be understood that the invention described may be useful in many industrial applications and may be modified and adapted in several ways without thereby departing from the scope of the inventive concept. Moreover, all the details of the invention may be substituted by technically equivalent elements.

1. An apparatus (10) for calibrating measuring instruments, such as bore gauges and the like, and comprising means for supporting the apparatus and calibrating means having contact means for the respective ends of the measuring ends (15,17) of the instrument to be calibrated, these means being, for each measuring end of the instrument to be calibrated, in the form of a first and a second contact surface (31,33d); the apparatus being characterised in that it comprises at least one adapter element (50) on at least one of the contact surfaces of the calibrating apparatus, said adapter element being designed to receive and support a respective end of the measuring instrument by adjusting to its profile.

2. The apparatus (10) according to claim 1, characterised in that the contact means comprise a fixed block (14) that supports a respective end (15) of the measuring instrument.

3. The apparatus (10) according to claim 1, characterised in that the contact means comprise a mobile block (16) that supports the other end (17) of the measuring instrument.

4. The apparatus (10) according to claim 1, characterised in that the blocks (14,16) that mount the contact means are aligned in a substantially horizontal direction.

5. The apparatus (10) according to claim 3, characterised in that it comprises means for driving the mobile block.

6. The apparatus (10) according to claim 5, characterised in that the means for driving the mobile block comprise means for guiding the mobile block.

7. The apparatus (10) according to claim 6, characterised in that the means for guiding the mobile block comprise a guide rod (20,21).

8. The apparatus (10) according to claim 1, characterised in that it comprises a fixed mounting block (22) opposite the fixed block (14).

9. The apparatus (10) according to claim 6, characterised in that the guide means extend transversally between the fixed block (14) and an opposite fixed mounting block (22).

10. The apparatus (10) according to claim 5, characterised in that the means for driving the mobile block comprise means for feeding the mobile block.

11. The apparatus (10) according to claim 10, characterised in that the means for feeding the mobile block comprise a drive shaft (21) that is operatively connected to the mobile block (16).

12. The apparatus (10) according to claim 11, characterised in that the drive shaft (21) is rotatably mounted on the fixed end blocks (20,22).

13. The apparatus (10) according to claim 1, characterised in that means are provided for controlling the apparatus.

14. The apparatus (10) according to claim 1, characterised in that means are provided for determining the calibration measurement.

15. The apparatus (10) according to claim 14, characterised in that the means for determining the calibration measurement comprise means for detecting the position of the mobile block (16).

16. The apparatus (10) according to claim 14, characterised in that the means for determining the calibration measurement comprise means for storing the position of the mobile block (16).

17. The apparatus (10) according to 16 claim 14, characterised in that the detecting means comprise sensor means on the mobile block (16).

18. The apparatus (10) according to claim 14, characterised in that the detecting means comprise a graduated reference rod.

19. The apparatus (10) according to claim 18, characterised in that the detecting means comprise a graduated rod positioned in front of the means for driving the mobile block (16).

20. The apparatus (10) according to claim 1, characterised in that it comprises means for connecting the adapter (50) to the block.

21. The apparatus (10) according to claim 1, characterised in that it comprises means for positioning the adapter (50) on the respective mounting block.

22. The apparatus (10) according to claim 20, characterised in that the connecting means are used to connect the adapter (50) to the fixed block.

23. The apparatus (10) according to claim 20, characterised in that the means for connecting the adapter (50) comprise holes (53,55) into which respective pins provided on the head of the apparatus are inserted.

24. The apparatus (10) according to claim 23, characterised in that the holes (53,55) are made in a bottom surface (54) of the adapter element (50).

25. The apparatus (10) according to claim 20, characterised in that spring means are provided for pushing the adapter element (52) towards and against an opposite vertical surface (60) of the fixed block (14).

26. The apparatus (10) according to claim 25, characterised in that the spring pushing means comprise springs (61,63′), each supporting a respective insertion pin and being oriented vertically and being housed in respective vertical holes (62, 64) made in the fixed block (14).

27. The apparatus (10) according to claim 1, characterised in that the adapter element (52) comprises a groove (63) which forms a passage for the end (15) of the measuring instrument which extends towards and against a contact surface.

28. The apparatus (10) according to claim 1, characterised in that the adapter element (52) comprises a first and a second lateral surface (71,73) abutting against the shaped end (15) of the measuring instrument (11).

29. The apparatus (10) according to claim 1, characterised in that the adapter element (52) comprises a rear or perpendicular surface abutting against the shaped end (15) of the measuring instrument (11).

30. The apparatus (10) according to claim 29, characterised in that the rear abutting surface for the shaped end (15) of the measuring instrument (11) is provided by a rear surface (75) of the adapter having a defined thickness.

31. The apparatus (10) according to claim 1, characterised in that the adapter element (52) comprises a bottom surface (65) supporting the shaped end (15) of the measuring instrument (11).

32. The apparatus (10) according to claim 31, characterised in that the bottom surface (65) for supporting the shaped end (15) of the measuring instrument (11) comprises a first and a second inwardly converging inclined part (67,69).

33. The apparatus (10) according to claim 31, characterised in that the adapter element (152) comprises a flat bottom surface (165) for supporting said end.

34. The apparatus (10) according to claim 1, characterised in that the adapter element (152) comprises a first and a second bottom seat (180,182) for accommodating a respective lateral portion of the shaped end (15) of the measuring instrument (11).

35. The apparatus (10) according to claim 31, characterised in that the adapter element (252) comprises a bottom forwardly inclined surface (265) supporting the shaped end (15) of the measuring instrument (11).

36. The apparatus (10) according to claim 31, characterised in that the adapter element (352) comprises an upwardly curved bottom surface (365) supporting the shaped end (15) of the measuring instrument (11).

37. The apparatus (10) according to claim 1, characterised in that the adapter element (550) comprises a thick bottom surface (567).

38. The apparatus (10) according to claim 27, characterised in that the adapter element (550) comprises a substantially triangular groove (563), with downwardly converging surfaces, for the passage of the end of the measuring instrument to be calibrated.

39. The apparatus (10) according to claim 1, characterised in that the adapter element (50) comprises rear longitudinal guide walls (79a, 79b) for the insertion of opposite lateral faces of the portion (31a) which bears the contact surface (31).

40. The apparatus (10) according to claim 1, characterised in that mobile means are provided for closing a groove(13′) in the frame cover of the apparatus.

41. The apparatus (10) according to claim 40, characterised in that the means for closing the groove(13′) in the frame consist of a flexible strip or tape (23).

42. The apparatus (10) according to claim 1, characterised in that it comprises means for supporting a measuring instrument, said supporting means having at least one portion that is mobile between a position where the instrument is supported and a retracted position.

43. The apparatus according to claim 1, characterised in that it comprises means for supporting long measuring instruments extending between the first and the second contact surface, said intermediate supporting means having at least one portion that is mobile between a position where the instrument is supported and a retracted position.

44. The apparatus according to claim 1, characterised in that it comprises means for supporting long measuring instruments extending between the first and the second contact surface, said intermediate supporting means being permanently fixed to the apparatus mounting means.

45. The apparatus according to claim 42, characterised in that the retracted position of the intermediate supporting means is a rest position.

46. The apparatus according to claim 1, characterised in that the contact means for respective ends of the measuring instrument to be calibrated comprise a first and a second contact surface, which move relative to each other, for a respective end of the instrument to be calibrated.

47. The apparatus according to claim 1, characterised in that the fixed block (014) comprises an abutting member (0140) rigidly fixed to the base (012).

48. The apparatus according to claim 47, characterised in that the abutting member (0140) has a portal frame structure.

49. The apparatus according to claim 47, characterised in that the fixed block (014) has opposite longitudinal extensions (01405,01406) with respective holes(014051,01405″,01406′,01406″,01407′, 01408′) through which respective screws are inserted into the base of the apparatus.

50. The apparatus according to claim 47, characterised in that the fixed block (014) comprises a contact element (031) mounting body or block (0141) that is fitted in and retained by a long cavity (0142) made in the top of the abutting member (0140).

51. The apparatus according to claim 1, characterised in that the supporting block (014) is equipped with plates (0148,0149) forming respective front surfaces (0150,0151) for engaging the rear surface of suitable adapter means.

52. The apparatus according to claim 1, characterised in that the side walls (0146,0147) constitute longitudinal lateral surfaces (0146a, 0147a) for guiding and centring respective surfaces of the adapter.

53. The apparatus according to claim 1, characterised in that it comprises means(T1, T2) for locking the adapter in the working position.

54. The apparatus according to claim 53, characterised in that the locking means (T1, T2) are provided on the fixed block (014).

55. The apparatus according to claim 53, characterised in that the locking means(T1, T2) engage the back of a respective adapter.

56. The apparatus according to claim 53, characterised in that the locking means(T1, T2) exert a pulling action on the adapter.

57. The apparatus according to claim 53, characterised in that the locking means (T1, T2) extend in a direction perpendicular to the retaining means (056,058).

58. The apparatus according to claim 53, characterised in that the locking means(T1, T2) can be actuated from the rear face (0140b, 0140c) of the abutting member (0140).

59. The apparatus according to claim 53, characterised in that the locking means comprise at least one horizontal through hole (0144a, 0144b) extending between respective rear faces (0140b, 0140c) and front faces (0150,0151) of the abutting member (0140); the through hole (0144a, 0144b) being designed to receive a respective screw (T1, T2) for fastening the adapter.

60. The apparatus according to claim 1, characterised in that it comprises a mobile block (016) comprising a transversally mobile abutting member (0160) and a contact element (033) mounting body or block (0161) that is fitted in and retained by a long cavity (0162) in the abutting member (0160).

61. The apparatus according to claim 60, characterised in that means (0163,0165) are provided for holding the block (0161) to the bottom mobile block (0160).

62. The apparatus according to claim 19, characterised in that the detecting means (025) lie in a substantially vertical plane.

63. The apparatus according to claim 10, characterised in that the means (021) for actuating the mobile block are parallel with and spaced from the guide rod (020).

64. The apparatus according to claim 10, characterised in that the means (021) for actuating the mobile block are parallel, and aligned substantially vertically, with a rod that supports the measuring rule.

65. The apparatus according to claim 1, characterised in that means are provided for transmitting motion to the means (023) that close the groove (013′) in the frame cover of the apparatus, these means being mounted on the mobile block.

66. The apparatus (10) according to claim 1, characterised in that it comprises an adapter element (050) consisting of a single body that defines a respective contact surface for a respective end of a measuring instrument to be calibrated.

67. The apparatus (10) according to claim 1, characterised in that it comprises an adapter element (050) consisting of a single body that comprises a first and a second contact surface (053a, 055a) for a respective end of a measuring instrument to be calibrated.

68. The apparatus (10) according to claim 1, characterised in that it comprises an adapter element (050) that makes it possible to obtain an apparatus with a plurality of contact surfaces for measuring instrument sensing ends (015a, 015b, 015c) positioned at angular intervals of 120 from each other.

69. The apparatus (10) according to claim 68, characterised in that the adapter element (050) comprises an abutting member (052) constituting means for supporting a first and a second sensing end (015a) and (015b) of the measuring instrument(011), while the other sensing end (015c) simply abuts against the mobile contact surface (033).

70. The apparatus according to claim 66, characterised in that the adapter element (050) comprises at least one vertical surface abutting against a respective end of a measuring instrument.

71. The apparatus according to claim 66, characterised in that the adapter element (050) comprises at least one bottom surface (065) for supporting the shaped end (015a) of the measuring instrument(011a).

72. The apparatus according to claim 1, characterised in that it comprises an adapter (0150) that is adjustable in height.

73. The apparatus according to claim 72, characterised in that it comprises an adapter (0150) consisting of a first element (0151) having a fixed bottom portion (0152) that supports a top portion (0153) that is vertically mobile in order to adjust the height of the supporting portion of the instrument to the different lengths of the measuring instrument.

74. The apparatus according to claim 73, characterised in that the mobile top portion (0153) has a forked portion(0154) with a first and a second substantially horizontal leg (0154a, 0154b) forming a gap for the passage of the stem(011′b) of the measuring instrument (011b) towards the calibrating area.

75. The apparatus according to claim 1, characterised in that the adapter (150) comprises an annular element (0160) constituting an abutting member for supporting the measuring instrument.

76. The apparatus according to claim 75, characterised in that the abutting member (0160) of the measuring instrument comprises a through hole (0161) that is adjustable in diameter.

77. The apparatus according to claim 1, characterised in that the adapter means (0250) comprise a first adapter element (0251) associable with the contact surface (031) on the fixed head, and a second adapter element (0252), associable with the contact surface (033) on the mobile head.

78. The apparatus according to claim 1, characterised in that the adapter element (0251) comprises a top surface (0253) with a central hole (0254) providing a passage for the contact means supporting elements.

79. The apparatus according to claim 1, characterised in that the first adapter element (0251) comprises a longitudinal channel (0254) that extends on both the front and back of the contact element.

80. The apparatus according to claim 77, characterised in that the second adapter element (0252) of this assembly has a central hole (0264) providing a passage for the contact surfaces and for its supporting elements.

81. The apparatus according to claim 77, characterised in that the second adapter element (0252) has a top surface (0263) forming a central, longitudinal channel (0264), having a front or downstream part (0264b) and a rear or upstream part (0264a).

82. The apparatus according to claim 1, characterised in that the adapter element (0251) comprises a portion for guiding the respective sensing end of the measuring instrument, this portion comprises a groove (0352) located behind the contact means.

83. The apparatus according to claim 1, characterised in that the adapter element (0351) comprises a pair of parallel longitudinal elements (0356,0357) that support the guide plate and are located in front of the contact element.

84. The apparatus according to claim 77, characterised in that a second adapter element (0352), associated with the mobile head (016), forms a triangular or dovetail groove (0362) constituting an abutting portion for a sensing end of a measuring instrument.

85. The apparatus according to claim 1, characterised in that the adapter (0450) consists of a single hollow body with a hole (0452) at the top of it for the passage of the bottom end of the measuring instrument(011e).

86. The apparatus according to claim 1, characterised in that the adapter (0450) has a bottom (0455) having a hole (0457) for receiving the lower end of respective measuring instrument.

87. The apparatus according to claim 1, characterised in that the adapter element (0450) has a front opening for the passage of the mobile contact element.

88. The apparatus according to claim 1, characterised in that the adapter element (0450) comprises a rear opening (0459) for insertion towards the end of the instrument abutting against the contact surface (031) on the fixed head (014).

89. The apparatus according to claim 1, characterised in that the base plate (612) also mounts pre-recording means for a tool of a machine tool.

90. The apparatus according to claim 89, characterised in that the tool pre-recording means comprise a mobile target (617) and a fixed seat (621) for accommodating the tool.

91. The apparatus according to claim 89, characterised in that it comprises a single mobile body (615) that mounts both the pre-recording target (617) and the calibrating contact element (633).

92. The apparatus according to claim 89, characterised in that the fixed head (614) for the contact element (631) for calibrating a measuring instrument is provided at the end opposite the seat (621) for pre-recording the tool.

93. A method for calibrating measuring instruments, said method being characterised in that it comprises a step of setting the calibration measurement to a value equal to the real calibration measurement plus an additional length calculated as the mean tolerance allowed for that calibration measurement.

94. An adapter for at least one end of a measuring instrument, characterised in that it is made according to claim 1.
